(19) United States
(12) Patent Application Publication
(10) Pub. No.: US 2026/0079672 A1
(43) Pub. Date: Mar. 19, 2026

(54) COMPUTING IN MEMORY (CIM) DEVICE AND A TRAINING METHOD FOR ITS SCALING COEFFICIENTS

(71) Applicant: National YANG MING Chiao Tung University, Hsinchu (TW)

(72) Inventors: Tian-Sheuan Chang, Hsinchu (TW); Ming-Han Lin, Hsinchu (TW)

(21) Appl. No.: 19/086,784

(22) Filed: Mar. 21, 2025

(30) Foreign Application Priority Data
Sep. 16, 2024 (TW) 113135131

(51) Int. Cl. G06F 5/01; G06F 17/15

(52) U.S. Cl. CPC G06F 5/01; G06F 17/15

(57) ABSTRACT

A training method that uses an AI module to train scaling coefficients is disclosed. The training method includes the following steps: (a) providing an input feature (F-in), plural convolution kernels, and a first fusion scaling coefficient, wherein each of the plural convolution kernels has a weight feature (W), and the first fusion scaling coefficient includes a first weight scaling factor (Sw) and a first partial sum scaling factor (Sp); (b) performing a first scaling operation on the weight feature (W) and the first fusion scaling coefficient to obtain a first scaling weight (WS); and (c) quantizing the first scaling weight (WS) to obtain a first quantized weight (Q(WS)), and performing a convolution sum operation on the first quantized weight (Q(WS)) and the input feature (F-in) to obtain a first convolution sum.

### CROSS-REFERENCE TO RELATED APPLICATIONS

The application claims the benefit of Taiwan Application No. 113135131, filed on Sep. 16, 2024, at the TIPO, the disclosures of which are incorporated herein in their entirety by reference.

### RELATED FIELD

The present invention relates to the field of artificial intelligence, and can be applied to edge devices of digital consumer electronics and Internet of Things (IoT) devices.

### BACKGROUND

Deep learning is an important application for AI chips, and smart consumer electronic products occupy a pivotal position in both the U.S. and the global electronic markets. According to a report by the market research firm IDC, the AI industry is expected to grow at a compound annual growth rate of 17.5% in the future, and the total revenue will exceed US$500 billion by 2024.

According to the exhibition content of the Consumer Electronics Show (CES) 2022 in the United States, computers, electric vehicles, health care, and metaverse applications are the main themes of this exhibition, all of which are extended applications with AI smart chips as the core. This shows the development and influence of AI technology on the industry.

Therefore, in summary, the development of low-energy AI chip systems is an inevitable development trend. On the one hand, the United States has a very large market for consumer electronics; on the other hand, it has the greatest influence on the whole world in terms of technology protection. Therefore, if this technology can obtain a U.S. patent, it will certainly help the future development of related domestic industries.

In the operation of AI chips, neural network operations will use a large number of multiplication and addition operations. Operations using the traditional Von Neumann (Von Neumann) architecture will face power consumption caused by a large amount of data movement. However, the computing-in-memory (CIM) integrates computing units and memory units. This architecture can save most of the data access and movement. Therefore, the computing-in-memory has high potential to achieve low energy consumption and high energy efficiency in the operation of neural networks.

However, the limited memory size causes the network to perform computing-in-memory operations in batches during the process, thereby generating multiple partial sums. When quantizing partial sums to simulate the analog-to-digital conversion (ADC) operation, the ADC input value often does not match the ADC quantization range, causing the ADC to be unable to effectively use its resolution range.

Since the wordline (WL) of the computing-in-memory (CIM) operation is affected by the size of the memory, a convolution operation needs to be split into several CIM operations to generate several partial sums. However, the error amount of partial sums read out via the ADC is greatly affected by the quantization range and bit number of the ADC itself.

The conventional techniques for partial sum quantification are mainly divided into two types: one is to design the corresponding ADC according to the partial sum statistics, and the other is to automatically adjust the partial sum size to match the ADC of fixed specifications. The latter is more flexible, and can match different partial sum distributions at the same time.

The method used by the latter is to convert the quantization step size or quantization range of the ADC into learnable parameters, and train them together with the model weight parameters. After the training is completed, each bit line (BL) of the CIM will correspond to a specific amplification factor, and the voltage accumulated by the BL can cause the partial sum to be amplified to the quantization range of the ADC through an additional amplifier. In this way, even if the partial sum does not match the quantization range of the ADC, it can be dynamically adjusted by the amplifier.

Another method is to adjust the reference voltage of the ADC to achieve the effect of dynamically adjusting the quantization range of the ADC. However, the above method will require additional amplifiers, or need to change the ADC reference voltage to achieve the effect.

Other approaches seek to create a universal CIM hardware unit by automatically scaling partial sums. One of the approaches uses the truncation threshold of the partial sums as a learnable parameter. The other two approaches refer to the learnable quantization step size, and apply this method to the quantization process of the partial sums. However, there are some differences among the three approaches when dealing with the implementation of the quantization steps of the partial sums in the computing-in-memory. One method is to achieve the effect of amplifying the partial sums through an analog amplifier at the end of the bit line. The other method is to adjust the resolution range of the ADC by adjusting the reference voltage of the ADC.

The U.S. Pat. No. 11,899,742 proposes a method of segmenting and quantizing the input activations and convolution kernels, and then performing batch convolution inside the CIM hardware to generate partial sums. In this process, the generated partial sums need to undergo additional multiplication and amplification to make their value range conform to the resolution range of the ADC for final partial sum quantization. The U.S. Pat. No. 11,423,315 proposes the number distribution of partial sums to determine the partial sum interval represented by each output value, thus achieving nonlinear quantization. By adjusting the boundaries of these intervals, the quantization error can be reduced. This nonlinear ADC is customized to specific partial sum distributions, which helps improve accuracy. However, such customized CIM hardware unit cannot be universally used between different models because the partial sum distributions of different models may be different. The above approaches are mainly to adjust the circuit. Since the model generates many partial sums during operation, the above approaches must record the amplification of each amplifier or the reference voltage of each ADC, and needs to switch them at any time. In addition to increasing hardware costs, these approaches are also inconvenient to operate.

### BRIEF SUMMARY

Most of the existing technologies design ADCs for neural network models, which results in the CIM hardware being not universally applicable to all models. In addition, dynamically adjusting the ADC reference voltage or adding amplifiers on the bit lines not only requires more hardware costs, but also makes the operation more complex.

Compared to the traditional digital hardware architecture, the computing-in-memory hardware execution neural network has the advantage of low power consumption. However, the quantization error of the ADC will have a decisive impact on the accuracy. Therefore, how to design a low-digit ADC while maintaining the accuracy has become the largest research topic in the computing-in-memory field.

In view of the above-mentioned deficiencies of the prior art, the technical feature of the present invention is to adjust the weights to comply with the ADC quantization range without additional circuit overheads. Since different types of models may lead to different distributions of partial sums, but the ADC specifications may be determined during the CIM macro design, a method that can dynamically adjust the ADC quantization range is highly desired. In order to avoid extra circuit overheads, this method does not manipulate the ADC, but adjusts the weights instead, so that the adjusted partial sums can be accurately read out by the ADC without additional operations.

In accordance with one aspect of the present invention, a training method for scaling coefficients of a computing in memory (CIM) device is disclosed. The training method includes the following steps: (a) providing a pre-training quantization model to obtain a first weight scaling coefficient (Sw) and a first partial sum scaling coefficient (Sp); (b) providing an input feature (F-in) and a CIM memory array corresponding to plural convolution kernels, wherein each of the plural convolution kernels has a weight feature (W); (c) performing a first scaling operation on the weight feature (W), the first weight scaling coefficient (Sw), and the first partial sum scaling coefficient (Sp) to obtain a first scaling weight (WS), wherein the first weight scaling coefficient (Sw) and the first partial sum scaling coefficient (Sp) are fused into a first fused scaling coefficient; (d) quantizing the first scaling weight (WS) to obtain a first quantized weight (Q(WS)), and performing a convolution summation operation on the first quantized weight (Q(WS)) and the input feature F-in to obtain a first convolution sum; and (e) quantizing the first convolution sum to obtain a first quantized convolution sum, and performing a first inverse scaling operation of the first scaling operation on the first quantized convolution sum to obtain a forward propagation result.

In accordance with another aspect of the present invention, a computing-in-memory (CIM) device having scaling factors is disclosed. The CIM device includes a CIM memory array and an artificial intelligence (AI) module. The CIM memory array is configured to correspond to one of plural convolution kernels and receive an input feature (F-in), wherein each of the plural convolution kernel has a weight feature (W). The artificial intelligence (AI) module is electrically connected to the CIM memory array and provides a first weight scaling coefficient (Sw) and a first partial sum scaling coefficient (Sp), wherein the AI module is configured to: (A) perform a first scaling operation on the weight feature (W), the first weight scaling coefficient (Sw), and the first partial sum scaling coefficient (Sp) to obtain a first scaling weight (WS), wherein the first weight scaling coefficient (Sw) and the first partial sum scaling coefficient (Sp) are fused into a first fused scaling coefficient; (B) quantize the first scaling weight (WS) to obtain a first quantized weight (Q(WS)), and perform a convolution summation operation on the first quantized weight (Q(WS)) and the input feature (F-in) to obtain a first convolution sum; and (C) quantize the first convolution sum to obtain a first quantized convolution sum, and perform a first inverse scaling operation of the first scaling operation on the first quantized convolution sum to obtain a forward propagation result.

In accordance with a further aspect of the present invention, a training method that uses an AI module to train scaling coefficients is disclosed. The training method includes the following steps: (a) providing an input feature (F-in), plural convolution kernels, and a first fusion scaling coefficient, wherein each of the plural convolution kernels has a weight feature (W), and the first fusion scaling coefficient includes a first weight scaling factor (Sw) and a first partial sum scaling factor (Sp); (b) performing a first scaling operation on the weight feature (W) and the first fusion scaling coefficient to obtain a first scaling weight (WS); and (c) quantizing the first scaling weight (WS) to obtain a first quantized weight (Q(WS)), and performing a convolution sum operation on the first quantized weight (Q(WS)) and the input feature (F-in) to obtain a first convolution sum.

Since different models may produce different partial sums when performing computing-in-memory operations, an ADC with fixed specifications cannot cope with these different partial sums, resulting in a loss of accuracy. Therefore, the present invention adjusts the weight size according to the fixed ADC specifications, hoping to make the input value of the ADC consistent with its own specifications, so that the entire resolution range of the ADC can be utilized without additional circuit overheads.

The method proposed by the present invention can be widely used in the computing-in-memory operations, and solves the problem of the ADC input voltage (or current) being inconsistent with the ADC's own quantification specifications by adjusting model weights without adding additional overheads.

Compared with existing technical practices, the technology proposed in the present invention has lower hardware complexity, and the potential to be more versatile and consume less power.

The above objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing a training process of a scaling factor of a computing-in-memory device according to a preferred embodiment of the present disclosure;

FIG. 2 is a schematic diagram of formations for mapping a memory array of a computing-in-memory device to weight features and partial sum according to a preferred embodiment of the present disclosure;

FIG. 3 is a schematic diagram showing a method for training a scaling factor of a computing-in-memory device according to a preferred embodiment of the present disclosure;

FIG. 4 is a schematic diagram showing a data transmission method for training a model according to a preferred embodiment of the present disclosure;

FIG. 5 is a schematic diagram showing the initial value setting of the quantization step length according to a preferred embodiment of the present disclosure;

FIG. 6 is a schematic diagram showing the distribution of a partial sum according to a preferred embodiment of the present invention; and

FIG. 7 is a schematic diagram showing ADC step size and accuracy according to a preferred embodiment of the present invention;

FIG. 8 is a schematic diagram showing a computing-in-memory device having a scaling factor according to a preferred embodiment of the present invention;

FIG. 9 is a schematic diagram showing a training method for training scaling factors using an AI module according to a preferred embodiment of the present invention; and

FIG. 10 is a schematic diagram showing a training method for training scaling factors using an AI module according to another preferred embodiment of the present invention.

### DETAILED DESCRIPTION OF VARIOUS EMBODIMENTS

Please read the following detailed description with reference to the accompanying drawings of the present invention. The accompanying drawings of the present invention are used as examples to introduce various embodiments of the present invention and to understand how to implement the present invention. The embodiments of the present invention provide sufficient content for those skilled in the art to implement the embodiments of the present invention, or implement embodiments derived from the content of the present invention. It should be noted that these embodiments are not mutually exclusive with each other, and some embodiments can be appropriately combined with another one or more embodiments to form new embodiments; that is, the implementation of the present invention is not limited to the examples disclosed below. In addition, for the sake of brevity and clarity, relevant details are not excessively disclosed in each embodiment, and even if specific details are disclosed, examples are used only to make readers understand. The present invention will now be described more specifically with reference to the following embodiments. It is to be noted that the following descriptions of the preferred embodiments of this invention are presented herein for the purposes of illustration and description only; they are not intended to be exhaustive or to be limited to the precise form disclosed.

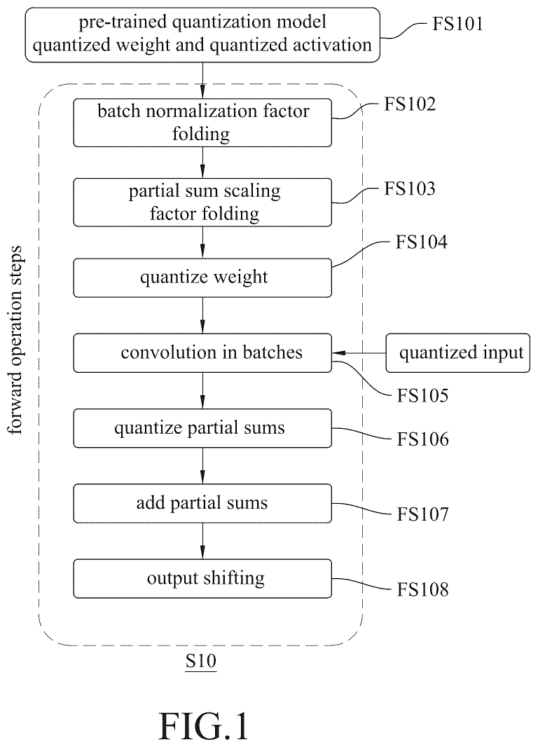

Please refer to FIG. 1, which is a schematic diagram showing a training process FS10 of a scaling coefficient of a computing-in-memory (CIM) device according to a preferred embodiment of the present invention. At first, in the step FS101, a pre-trained (or early stage) quantization model needs to be used, which has already quantized the weights and activations (for example, 4 bits). The purpose of this is to serve as a starting point for the subsequent quantification process. Next, the steps FS102 to FS108 are the forward operations of model training. In the step FS102, in order to reduce the amount of parameters, batch normalization (BN) parameters can be combined with convolution kernel weights. Then, in the step FS103, these combined weights are multiplied by corresponding scaling coefficients, so that the generated partial sums match the input specification of the ADC. Subsequently, in the step FS104, the new weights are quantized by 4 bits.

Next, in the step FS105, the quantized weights are convolved with the input in batches to obtain partial sums. In the step FS106, the partial sums may be quantized according to the specifications of the ADC, and then in the step FS107, these quantized values are added to obtain the sum. In the step FS108, the sum may be inversely scaled based on the original partial sum scaling factors and the weight scaling factors. The entire process can be simplified to a bit-shifting operation in the circuit without the use of expensive multipliers.

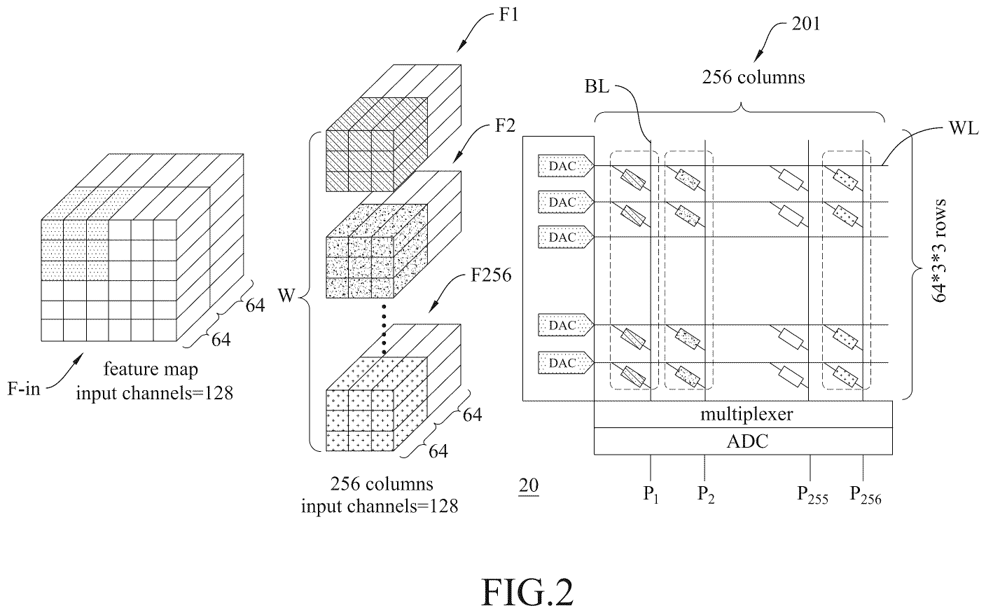

Please refer to FIG. 2, which is a schematic diagram showing that a memory array 201 of a computing-in-memory (CIM) device 20 is mapped to the weight feature W and the partial sums P1 to P256 according to a preferred embodiment of the present invention. FIG. 2 shows the operation of the convolution calculation. Due to the limitation of the number of rows of the memory array 201, the multiplication and addition operations cannot be completed at one time. Therefore, it is necessary to divide the convolution kernel into multiple blocks according to the number of rows of the memory array 201, and perform convolution in batches, and finally the partial sums are added to obtain the final convolution result. In this case, it becomes very important whether the ADC's quantification range and the partial sum distribution match each other. The convolution kernels F1, F2, . . . . F256 in FIG. 2 can be used as filters. The internal values of the convolution kernels F1, F2, . . . . F256 correspond to the weight values. For example, each convolution kernel F1, F2, . . . . F256 has 3*3*128 weight values, and the weight feature W contains these weight values. For example, in FIG. 2, since the memory array 201 has a total of 3*3*64 rows, the 256 convolution kernels F1, F2, . . . . F256 with a size of 3*3*128 need to be divided into 2 blocks, and the first half block is placed in the memory array 201, and convolved with the first half of the feature map F-in. After the operation is completed, the second half of the convolution kernel is loaded, and convolved with the second half of the feature map F-in. Because the input feature F-in has 128 input channels, and the number of rows of the memory array 201 is 3*3*64, it needs to be divided into two convolutions. The first half feature map is convoluted with the first half convolution kernel to generate a partial sum, the second half feature map is convolved with the second half convolution kernel to generate another partial sum, and the two partial sums are added to obtain the convolution result. In addition, there are a total of 256 convolution kernels F1, F2, . . . , F256. Therefore, 256 bit lines BL in the memory array 201 can be used to form 256 columns. The convolution kernel weights need to be reloaded once to complete the convolution operation.

In the conventional approaches, analog amplifiers are placed at the end of the columns of the memory array 201, or additional reference voltage adjustments are required for the ADC. The present invention makes the partial sums P1, P2, . . . . P255, P256 meet the specifications of the ADC by adjusting the weight feature W during the training process. Therefore, there is no need to place an analog amplifier at the end of the columns of the memory array 201 of the present invention, and the memory array 201 can be directly and electrically connected to the multiplexer and the ADC. The ADCs in FIG. 2 are configured as one ADC per column, for a total of 256 ADCs.

In any embodiment of the present invention, the determination of the ADC quantization range is mainly to convert the quantization step size (Sp) of the partial sum into a learnable parameter. The quantization process is shown in the following formula:

$$Formula 1$$

$$pseudo quantization to simulate the quantization error$$

$$\overline{Partial sum} = round ( clip ( \frac{Partial sum}{{S}_{p}} , min , max ) )$$

$$sum = \overline{Partial sum} \times {S}_{p}$$

The Clip function limits the maximum and minimum values, and the Round function rounds the value to an integer, such as rounding off. The input partial sum is firstly resized by the quantization step Sp, the oversized or undersized values are discarded, and the resized input partial sum are rounded off, and finally multiplied by the quantization step Sp to simulate the error caused by the quantization process. It can be found that a multiplication is required before and after quantization. In the present invention, the scale factor (1/Sp) before quantization is combined with the weight of the model, while the scale factor (Sp) after quantization can be obtained by the shift operation of the digital circuit. In the process of combining the pre-quantization scale factor (1/Sp) with the weight, the weight may exceed the original quantization range. Therefore, during the model training process, the quantization step size (Sw) of the weight will also be included in the learning process. When the combined weight is too large or too small, Sw will be adjusted in time to make the weight distribution match its own quantification range. The following is the original quantization method:

$$Formula 2$$

$$original quantization formula$$

$$Q ( \frac{[ Q ( \frac{W}{{S}_{w}} ) \times {S}_{w} ] ⊗ Input}{{S}_{p}} ) \times {S}_{p}$$

$$W : weight Sw : weight scaling factor Sp : partial sum scaling factor$$

$$Q ( ) : quantization ( \text{} including limiting maximum and minimum values and taking integers )$$

$$⊗ : batch convolution$$

Originally, both the weight W and the partial sum are independently quantized, as shown above, which is the practice of using amplifiers before the ADC processing. However, in order to simplify the entire CIM operation and save amplifiers, the two scaling factors (Sw, Sp) can be fused with the weights in advance, and then the scaling effect of the scaling factors (Sw, Sp) can be reversely scaled back after the convolution is completed, as shown in the following formula:

$$Formula 3$$

$$the improved quantization formula of the CIM$$

$$\begin{matrix}Q ( [ Q ( \frac{W}{{S}_{w}} ) \times {S}_{w} ] ⊗ Inp ut ) ⨯ {S}_{w} ⨯ {S}_{p} \\ New weight Digital Shift\end{matrix}$$

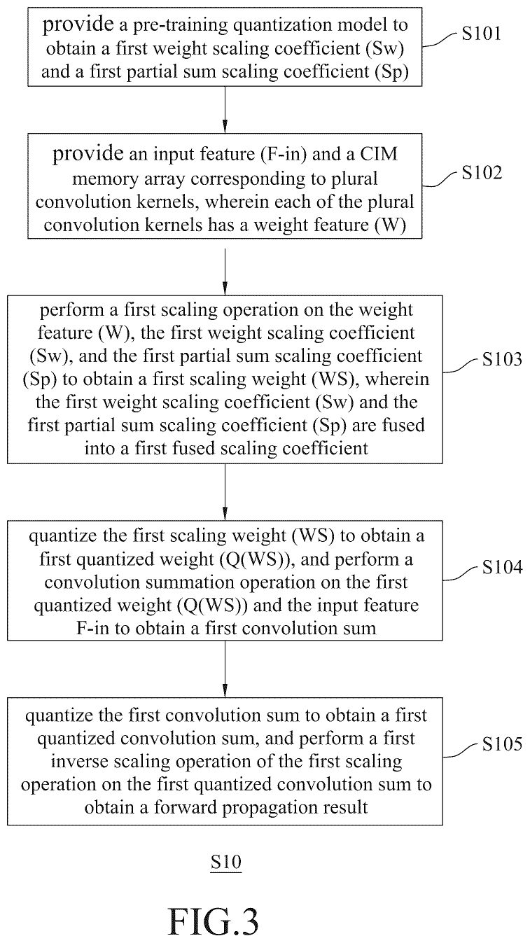

W/(Sw*Sp) in Formula 3 becomes the new weight, and the rightmost Sw*Sp can be simplified by digital circuit shift operations. After the partial sums are summed, scaling needs to be performed according to the quantization step sizes Sw and Sp, and Sw*Sp is usually less than 1. This can be accomplished by a simple digital right shift operation, saving the use of amplifiers. Therefore, Sw*Sp needs to be approximated as a value to the power of 2. Through this power term, the number of bits that need to be right-shifted for the convolution result can be determined. Please refer to FIG. 3, which is a schematic diagram of a training method S10 for scaling coefficients of a computing-in-memory (CIM) device according to a preferred embodiment of the present invention. Please refer to FIGS. 1˜2 and Formula 3 simultaneously. In the step S101, provide a pre-training quantization model to obtain a first weight scaling coefficient (Sw) and a first partial sum scaling coefficient (Sp). In the step S102, provide an input feature (F-in) and a CIM memory array corresponding to plural convolution kernels, wherein each of the plural convolution kernels has a weight feature (W). In the step S103, perform a first scaling operation on the weight feature (W), the first weight scaling coefficient (Sw), and the first partial sum scaling coefficient (Sp) to obtain a first scaling weight (WS), wherein the first weight scaling coefficient (Sw) and the first partial sum scaling coefficient (Sp) are fused into a first fused scaling coefficient. In the step S104, quantize the first scaling weight (WS) to obtain a first quantized weight (Q(WS)), and perform a convolution summation operation on the first quantized weight (Q(WS)) and the input feature F-in to obtain a first convolution sum. In the step S105, quantize the first convolution sum to obtain a first quantized convolution sum, and perform a first inverse scaling operation of the first scaling operation on the first quantized convolution sum to obtain a forward propagation result.

In any embodiment of the present invention, the first weight scaling coefficient Sw ranges from 0˜1. The first partial sum scaling factor Sp ranges from Sw˜1. The first scaling operation is an amplification operation, and the first scaling weight WS=W*(1/(Sw*Sp)). The quantizing of the first scaling weight WS is to limit the maximum value and the minimum value of the first scaling weight WS, and then take an integer. The quantization of the first convolution sum is to limit the maximum value and the minimum value of the first convolution sum, and then take an integer. In FIG. 3, the steps S102˜S105 are a forward propagation method of scaling coefficients.

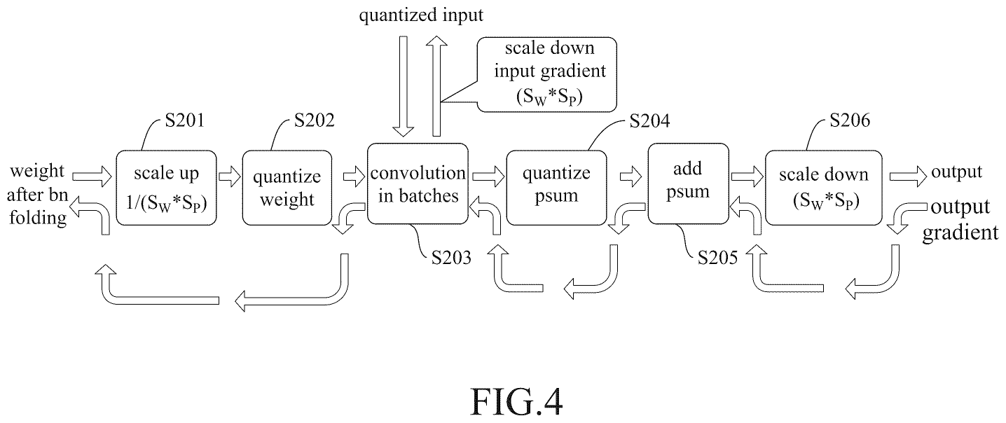

Please refer to FIG. 4, which is a schematic diagram of a data transfer method when training a model according to a preferred embodiment of the present invention. In FIG. 4, the forward and reverse operations during the training process are as follows. The weights after fusion with the batch normalization (BN) parameters are first amplified in the step S201, quantized in the step S202, and then convolved in batches with the input to obtain partial sums in the step S203. Next, in the step S204, the partial sums are quantized to simulate the operation of the ADC. Then, in the step S205, the partial sums are added, and finally in the step S206, the result is reduced back. During the gradient backtracking process, all upscaling, downscaling, and rounding operations are skipped to prevent weights from being affected by abnormal upscaling or downscaling. In addition, since the amplified weight and output gradient are used when calculating the input gradient, in the step S207, the input gradient must undergo reverse reduction of the weight amplification effect

In any embodiment of the present invention, the first inverse scaling operation includes digitally shifting the first quantized convolution sum. The scaling coefficient training method also includes a back propagation method, including the following steps: obtaining a weight gradient of the weight feature, a weight scaling gradient of the first weight scaling coefficient Sw, and a partial sum scaling gradient of a first partial sum scaling coefficient Sp based on the forward propagation result; and respectively updating the weight feature W, the first weight scaling coefficient Sw, and the first partial sum scaling coefficient Sp to obtain a subsequent weight feature, a second weight scaling coefficient, and a second partial sum scaling coefficient according to the weight gradient of the weight feature W, the weight scaling gradient of the first weight scaling coefficient Sw, and the partial sum scaling gradient of the first partial sum scaling coefficient Sp. The amplified weight (*1/(Sw*Sp)) in Formula 3 is for convolution with the input feature F-in. In an embodiment, the stored model weight parameters are not amplified. There are two weights in the forward operation; one is the weight amplified for the input convolution, and the other is the unamplified weight, which is a model parameter and will only be affected by gradient updates.

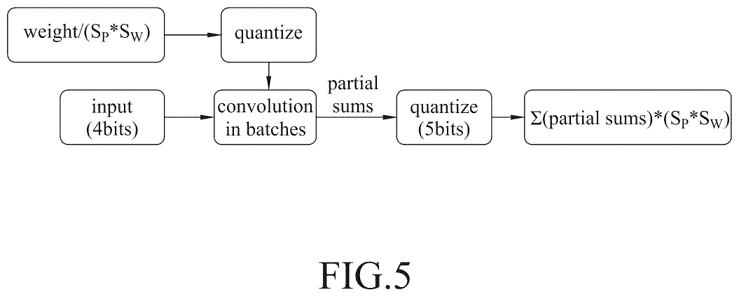

Please refer to FIG. 5, which is a schematic diagram of the initial value setting of the quantization step size according to a preferred embodiment of the present invention. It can be seen from FIG. 4 that the weight requires a quantization step size Sp during the forward operation, but Sp cannot be known without a convolution operation at this time. Therefore, the present invention proposes a method of initializing the quantization step sizes Sw and Sp. In one embodiment, the input is 4 bits, and a total of three iterations are required to gradually complete the initial value setting. In order to make the model converge more easily, when calculating the initial Sw and Sp, the following formula is used to initialize:

$$Formula 4$$

$$method of initializing the quantization step sizes Sw and Sp$$

$${S}_{w} = \frac{6 \times {σ}_{w}}{{2}^{{b}_{w}} - 1} , {S}_{p} = \frac{6 ⨯ {σ}_{p}}{( {2}^{{b}_{ADC}} - 1 ) ⨯ ADC step size}$$

$$( {σ}_{w} : weight standard deviation {σ}_{p} : partial sum standard deviation {b}_{w} : weight quantization bit number {b}_{A D C} : ADC quantization bit number )$$

It is worth noting that the ADC step size is the specification of the ADC, and it is set at the beginning and cannot be changed. The weight scaling factor (or coefficient) Sw is the quantization step size of the weight, and the partial sum scaling factor (or coefficient) Sp is the quantization step size of the partial sum; both are learnable parameters, so they can be changed. σ_{w} and σₚ can be pre-trained, and a probability model of normal distribution is assumed to obtain the standard deviation of the original weight and partial sum. Six times of the standard deviation of the original weight and partial sum is approximate to the distribution range of the original weight and partial sum, 2^{b}^{_{w}}−11 and 2^{b}^{_{ADC}}−1 represent the quantization level of the weight and partial sum, and the division of the two can represent the quantization step size. By adjusting the quantization step sizes Sw and Sp, the weight and partial sum can be scaled to fit a given ADC step size.
The iteration steps are as follows:

### Iteration 1:

Calculate the initial Sw0, and enlarge the weight (*1/Sw0).
Quantize the weight, and the quantized weight is convolved with the input to produce the partial sum.
Use the partial sum to calculate the initial Sp0 for the next use, add the partial sum to produce the result, and reduce the result (*Sw0).

### Iteration 2:

Enlarge the weight (*1/Sp0), recalculate the initial Sw1, and enlarge the weight (*1/Sw1).
Quantize the weight, and the quantized weight is convolved with the input to produce the partial sum.
Use the partial sum to recalculate the initial Sp1 for the next use, quantize the partial sum, and reduce the total result (*Sw1*Sp0).

### Iteration 3:

Enable automatic learning of the quantization step size, and enlarge the weight (*1/(Sw1*Sp1)) Quantize the weight.
Quantize the partial sum, and reduce the total result (*Sw1*Sp1).

In any embodiment of the present invention, the Iteration 1 and the Iteration 2 can be implemented on a non-hardware circuit outside the CIM, and the Iteration 3 is implemented on a hardware circuit of the CIM. The training method of the scaling coefficient further includes the following steps:

### Iteration Step 1:

Calculate an initial weight scaling coefficient Sw0 to scale the weight feature W to obtain an initial first scaling weight W0=W*(1/Sw0);
quantize the initial scaling weight W0 to a quantized initial first scaling weight Q(W0);
the quantized initial first scaling weight Q(W0) is convolved with the input feature F-in to obtain first plural partial sums; and
calculate an initial partial sum scaling coefficient Sp0, add the first plural partial sums up to obtain a first summation result, and multiply the first summation result by the initial weight scaling coefficient Sw0.

### Iteration Step 2:

The initial weight feature W is scaled by the initial partial sum scaling coefficient Sp0 to obtain an initial second scaling weight W1=W*(1/Sp0);
recalculate the initial weight scaling coefficient Sw0 to obtain the first weight scaling coefficient Sw1 so as to scale the initial second scaling weight W1 to obtain an initial third scaling weight W2=W1*(1/Sw1);
quantize the initial third scaling weight W2 to obtain a quantized initial fourth scaling weight W3=Q(W2);
the quantized initial fourth scaling weight W3 is convolved with the input feature F-in to obtain second plural partial sums;
recalculate the initial partial sum scaling factor Sp0 to obtain the first partial sum scaling factor Sp1; and
add the second plural partial sums up to obtain a second summation result, and multiply the second summation result by the first weight scaling coefficient Sw1 and the initial partial sum scaling coefficient Sp0;

### Iteration Step 3:

the quantized initial weight feature W is scaled by the first weight scaling coefficient Sw1 and the first partial sum scaling coefficient Sp1 to obtain an initial fifth scaling weight W4=W*(1/(Sw1*Sp1)), and the initial fifth scaling weight W4 is quantized to obtain a quantized initial sixth scaling weight W5=Q(W4);
the quantized initial sixth scaling weight W5 is convolved with the input feature F-in to obtain third plural partial sums; and
add the third plural partial sums up to obtain a third summation result, and multiply the third summation result by the first weight scaling coefficient Sw1 and the first partial sum scaling coefficient Sp1.

The advantages of the present invention are that no amplifier is required in the ADC processing stage, and no reference voltage needs to be adjusted so that the weights and partial sums can be scaled to meet a given ADC step size without adjusting the reference voltage. However, there are some restrictions on the initial quantization step sizes Sw0 and Sp0, such as the following Formula 5:

$$Formula 5$$

$$restrictions on Sw 0 and Sp 0$$

$$Sw 0 < S p 0 < 1$$

Restriction condition 1 (Sp0<1): the partial sum is only allowed to be amplified
If the ADC quantization range is too small, and the partial sum is expected to be reduced, the weight will be reduced after Sp0 folding.
But in order for the weight to use the full quantification range, the weight is amplified again to make the partial sum larger.
Restriction condition 2 (Sp0>Sw0): the partial sum magnification cannot be greater than the weight
If Sp0 is larger than Sw0, the weight will be amplified too much after folding, and the weight needs to be reduced again.
The reduced weight results in an even smaller partial sum.
Restriction condition 3: The amplified input must be synchronized with the amplified partial sum quantization range.
Because it is undesirable that the input size affects the folded weight to violate the above conditions, if the input size is adjusted, the quantization range of the partial sum must be adjusted synchronously. For example, if the input is amplified 16 times, the partial sum quantization range is amplified 16 times synchronously.
If the Restriction condition 1 is violated, it means that the partial sum is too large, and the convolution operation can be performed more times to reduce the partial sum.
If the Restriction condition 2 is violated, it means that the partial sum is too small, and multiple convolution operations can be combined to increase the partial sum.
The model can still be trained without complying with these conditions, but complying with these conditions will maximize the accuracy of the model.

The main feature of the present invention is to generate the partial sums which are consistent with the ADC specifications by adjusting the weights. The present invention is unlike other conventional techniques, which may require adding amplifiers or changing the ADC reference voltage to make the partial sums comply with the ADC specifications; that is, in the present invention, the weights require no additional operations after offline training is completed.

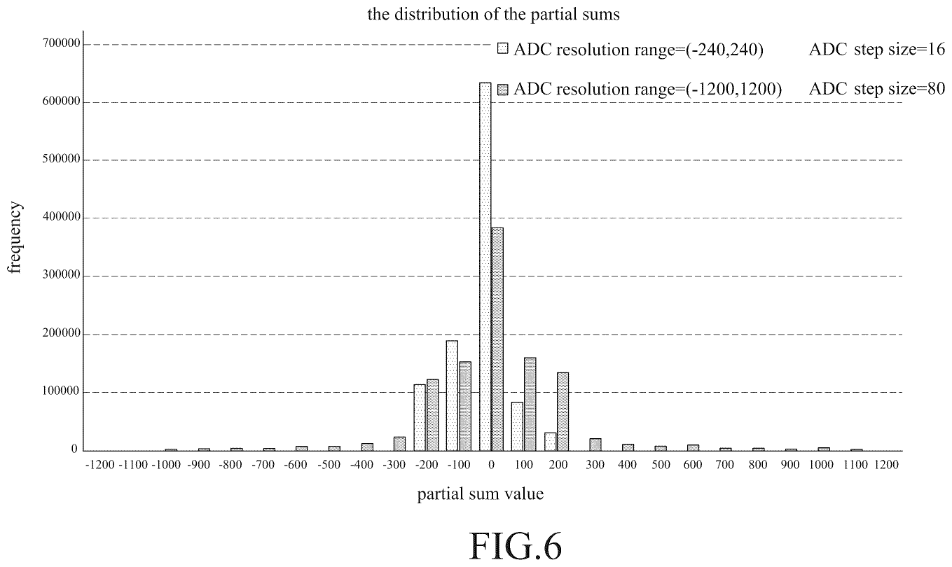

Please refer to FIG. 6, which is a schematic diagram showing the distribution of the partial sums according to a preferred embodiment of the present invention. The horizontal axis represents the value of the partial sum, and the vertical axis represents the number of times or frequency of occurrence in a certain partial sum. FIG. 6 shows the distribution of the partial sums trained for two different ADC specifications. For example, when the partial sum is quantized to 5 bits, the ADC step sizes 16 and 80 are applied respectively. It can be observed from the distribution diagram of the partial sums that the distribution of the partial sums becomes wider as the ADC resolution range increases. For example, the ADC with an ADC step size of 80 has a wider resolution range, in which the partial sum values range from −1200 to 1200. However, the ADC with an ADC step size of 16 has a narrower resolution range, in which the partial sum values range from −240 to −240. The number of times of occurrence in the partial sums with an ADC step size of 16 is relatively concentrated, but the number of times of occurrence in the partial sums with an ADC step size of 80 is relatively scattered.

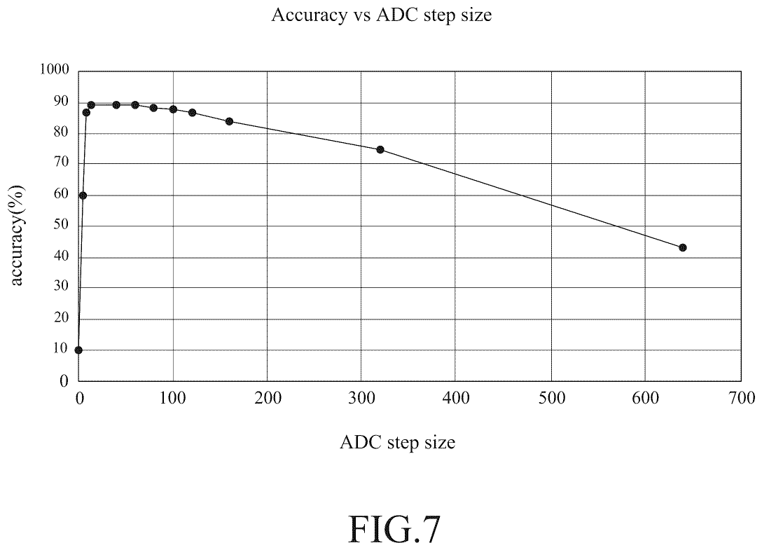

Please refer to FIG. 7, which is a schematic diagram of the ADC step size and accuracy according to a preferred embodiment of the present invention. The horizontal axis represents the step size of the ADC, and the vertical axis represents the quantization accuracy or precision of the ADC. In one embodiment, under the condition that the number of ADC quantization bits b_ADC is fixed, as the ADC quantization step size increases, the accuracy increases firstly and then decreases. Since the folding of the partial sum scaling coefficient Sp is limited by the quantization number b_w of the weight itself, when the ADC resolution range is too large or too small, the accuracy will be reduced because there is no way to freely scale the weight W in the CIM. The optimal ADC resolution range can correspond to the interval of Sw0<Sp0<1.

In any embodiment of the present invention, the weight feature W has a weight bit number, i.e. the weight quantization number b_{w} in Formula 4. The pre-training quantization model mentioned in the step S101 includes an analog-to-digital (ADC) unit, and the ADC unit has an ADC bit number b_{ADC}, an ADC step size, an ADC resolution range in FIG. 6, and an ADC quantization accuracy in FIG. 7. The first weight scaling coefficient Sw is related to the weight quantization bit number b_{w} in Formula 4 and a weight standard deviation σ_{w}. The first partial sum scaling factor Sp is related to the ADC bit number, the ADC step size, and a partial sum standard deviation σₚ. As shown in Formula 4, when the ADC bit number b_{ADC} is fixed, the ADC step size is related to the resolution range of the ADC shown in FIG. 6, and the quantization accuracy of the ADC shown in FIG. 7. The ADC unit also has a reference voltage, and in the steps S102˜S105, the first weight scaling coefficient Sw and the first partial sum scaling coefficient Sp are used to adjust the weight feature W so that the forward propagation result meets the reference voltage.

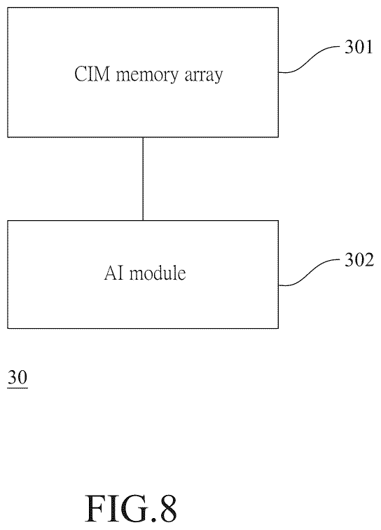

Please refer to FIG. 8, which is a schematic diagram of a computing-in-memory (CIM) device 30 having the scaling coefficients Sw, Sp according to a preferred embodiment of the present invention. The CIM device 30 includes a CIM memory array 301 and an artificial intelligence (AI) module 302. The CIM memory array 301 is configured to correspond to plural convolution kernels F1, F2, . . . , F256, and receive an input feature F-in, wherein each of the plural convolution kernels F1, F2, . . . , F256 has a weight feature W. The artificial intelligence (AI) module 302 is electrically connected to the CIM memory array 301, and provides a first weight scaling coefficient Sw and a first partial sum scaling coefficient Sp, wherein the AI module is configured to: (A) perform a first scaling operation on the weight feature W, the first weight scaling coefficient Sw, and the first partial sum scaling coefficient Sp to obtain a first scaling weight WS, wherein the first weight scaling coefficient Sw and the first partial sum scaling coefficient Sp are fused into a first fused scaling coefficient; (B) quantize the first scaling weight WS to obtain a first quantized weight Q(WS), and perform a convolution summation operation on the first quantized weight Q(WS) and the input feature F-in to obtain a first convolution sum; and (C) quantize the first convolution sum to obtain a first quantized convolution sum, and perform a first inverse scaling operation of the first scaling operation on the first quantized convolution sum to obtain a forward propagation result.

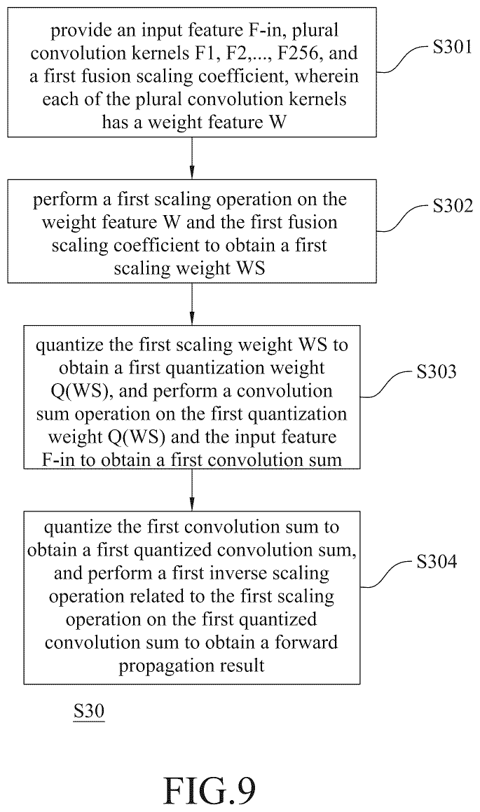

Please refer to FIG. 9, which is a schematic diagram of a training method S30 for training scaling coefficients using an AI module according to a preferred embodiment of the present invention. The training method S30 includes the following steps: providing an input feature F-in, plural convolution kernels F1, F2, . . . , F256, and a first fusion scaling coefficient, wherein each of the plural convolution kernels has a weight feature W (S301); performing a first scaling operation on the weight feature W and the first fusion scaling coefficient to obtain a first scaling weight WS (S302); quantizing the first scaling weight WS to obtain a first quantization weight Q(WS), and performing a convolution sum operation on the first quantization weight Q(WS) and the input feature F-in to obtain a first convolution sum (S303); and quantizing the first convolution sum to obtain a first quantized convolution sum, and performing a first inverse scaling operation related to the first scaling operation on the first quantized convolution sum to obtain a forward propagation result (S304).

In any embodiment of the present invention, the fusion coefficient includes the first weight scaling coefficient Sw and the first partial sum scaling coefficient Sp. The plural convolution kernels F1, F2, . . . , F256 correspond to the CIM memory array 301. The steps S301˜S304 are a forward propagation method of the scaling coefficients. The AI module includes an analog-to-digital (ADC) unit, and the ADC unit has an ADC bit number b_{ADC} in Formula 4, an ADC step size, an ADC resolution range in FIG. 6, and an ADC quantification accuracy in FIG. 7. The first weight scaling coefficient Sw is related to the weight quantization bit number b_{w} in Formula 4 and a weight standard deviation σ_{w}. The first partial sum scaling factor Sp is related to the ADC bit number, the ADC step size, and the partial sum standard deviation σₚ. As shown in Formula 4, when the ADC bit number b_{ADC} is fixed, the ADC step size is related to the resolution range of the ADC shown in FIG. 6, and the quantization accuracy of the ADC shown in FIG. 7. The ADC unit also has a reference voltage, and in the steps S301˜S304, the first weight scaling coefficient Sw and the first partial sum scaling coefficient Sp are used to adjust the weight feature W so that the forward propagation result meets the reference voltage.

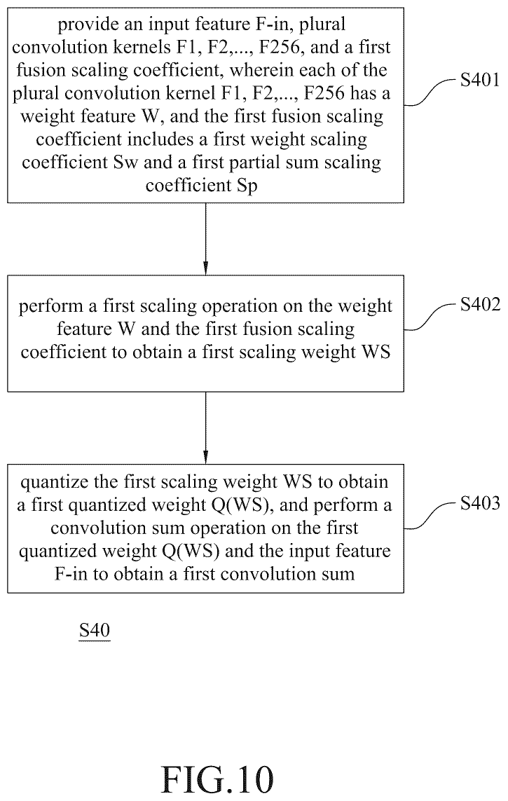

Please refer to FIG. 10, which is a schematic diagram of a training method S40 for training scaling coefficients using an AI module according to another preferred embodiment of the present invention. The training method S40 includes the following steps: providing an input feature F-in, plural convolution kernels F1, F2, . . . , F256, and a first fusion scaling coefficient, wherein each of the plural convolution kernel F1, F2, . . . , F256 has a weight feature W, and the first fusion scaling coefficient includes a first weight scaling coefficient Sw and a first partial sum scaling coefficient Sp (S401); performing a first scaling operation on the weight feature W and the first fusion scaling coefficient to obtain a first scaling weight WS (S402); and quantizing the first scaling weight WS to obtain a first quantized weight Q(WS), and performing a convolution sum operation on the first quantized weight Q(WS) and the input feature F-in to obtain a first convolution sum (S403).

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A training method for scaling coefficients of a computing-in-memory (CIM) device, comprising the following steps:
(a) providing a pre-training quantization model to obtain a first weight scaling coefficient (Sw) and a first partial sum scaling coefficient (Sp);
(b) providing an input feature (F-in) and a CIM memory array corresponding to plural convolution kernels, wherein each of the plural convolution kernels has a weight feature (W);
(c) performing a first scaling operation on the weight feature (W), the first weight scaling coefficient (Sw), and the first partial sum scaling coefficient (Sp) to obtain a first scaling weight (WS), wherein the first weight scaling coefficient (Sw) and the first partial sum scaling coefficient (Sp) are fused into a first fused scaling coefficient;
(d) quantizing the first scaling weight (WS) to obtain a first quantized weight (Q(WS)), and performing a convolution summation operation on the first quantized weight (Q(WS)) and the input feature F-in to obtain a first convolution sum; and
(e) quantizing the first convolution sum to obtain a first quantized convolution sum, and performing a first inverse scaling operation of the first scaling operation on the first quantized convolution sum to obtain a forward propagation result.

2. The training method as claimed in claim 1, wherein:
the initial weight scaling coefficient (Sw0) is between 0 and 1; and
the initial partial sum scaling factor (Sp0) is between Sw0 and 1.

3. The training method as claimed in claim 1, wherein:
the first scaling operation is an amplification operation, and the first scaling weight (WS) equals to W*(1/(Sw*Sp)).

4. The training method as claimed in claim 1, wherein:
the step of quantizing the first scaling weight (WS) defines a maximum value and a minimum value for the first scaling weight (WS) and then rounds the maximum value and the minimum value.

5. The training method as claimed in claim 1, wherein:
the step of quantizing the first convolution sum defines a maximum value and a minimum value for the first convolution sum and then rounds the maximum value and the minimum value.

6. The training method as claimed in claim 1, wherein the first inverse scaling operation includes bitwise shifting the first quantized convolution sum.

7. The training method as claimed in claim 1, wherein:
the steps (b) to (e) are performed in sequence; and
the training method further comprises the following steps:
obtaining a weight gradient of the weight feature (W), a weight scaling gradient of the first weight scaling coefficient (Sw), and a partial sum scaling gradient of the first partial sum scaling coefficient (Sp) according to the forward propagation result; and
respectively updating the weight feature (W), the first weight scaling coefficient (Sw) and the first partial sum scaling coefficient (Sp) to obtain a subsequent weight feature, a second weight scaling coefficient and a second partial sum scaling coefficient according to the weight gradient of the weight feature (W), the weight scaling gradient of the first weight scaling coefficient (Sw) and the partial sum scaling gradient of the first partial sum scaling coefficient (Sp).

8. The training method as claimed in claim 1, wherein:
the weight feature (W) has a weight bit number;
the pre-training quantization model includes an analog-to-digital (ADC) unit, and the ADC unit has an ADC bit number, an ADC step size, an ADC resolution range and an ADC quantization accuracy;
the first weight scaling coefficient (Sw) is related to the weight bit number and a weight standard deviation;
the first partial sum scaling factor (Sp) is related to the ADC bit number, the ADC step size and a partial sum standard deviation;
under the condition that the ADC bit number is fixed, the ADC step size is related to the ADC resolution range and the ADC quantization accuracy; and
the ADC unit further has a reference voltage, and in steps (b)-(e), the first weight scaling coefficient (Sw) and the first partial sum scaling coefficient (Sp) are used to adjust the weight feature (W), so that the forward propagation result satisfies the reference voltage.

9. The training method as claimed in claim 8, further comprises the following iterative steps:
an iterative step 1, including:
calculating an initial weight scaling coefficient (Sw0) to scale the weight feature (W) to obtain an initial first scaling weight (W0) equal to W*(1/Sw0);
quantizing the initial first scaling weight (W0) to be a quantized initial first scaling weight (Q(W0));
convoluting the quantized initial first scaling weight (Q(W0)) with the input feature (F-in) to obtain first plural partial sums; and
calculating an initial partial sum scaling coefficient (Sp0), summing the first plural partial sums to obtain a first summation result, and multiplying the first summation result by the initial weight scaling coefficient (Sw0);
an iterative step 2, including:
scaling the initial weight feature (W) by the initial partial sum scaling coefficient (Sp0) to obtain an initial second scaling weight (W1) equal to W*(1/Sp0):
recalculating the initial weight scaling coefficient (Sw0) to obtain the first weight scaling coefficient (Sw1) to scale the initial second scaling weight (W1) to obtain an initial third scaling weight (W2) equal to W1*(1/Sw1);
quantizing the initial third scaling weight W2 to obtain a quantized initial fourth scaling weight (W3);
convoluting the quantized initial fourth scaling weight (W3) with the input feature (F-in) to obtain second plural partial sums;
recalculating the initial partial sum scaling factor (Sp0) to obtain the first partial sum scaling factor (Sp1); and
summing the second plural partial sums to obtain a second summation result, and multiplying the second summation result by the first weight scaling coefficient (Sw1) and the initial partial sum scaling coefficient (Sp0); and
an iterative step 3, including:
scaling the quantized initial weight feature (W) by the first weight scaling coefficient (Sw1) and the first partial sum scaling coefficient (Sp1) to obtain an initial fifth scaling weight (W4) equal to W*(1/(Sw1*Sp1)).

10. A computing-in-memory (CIM) device having scaling factors, comprising:
a CIM memory array configured to correspond to one of plural convolution kernels and receive an input feature (F-in), wherein each of the plural convolution kernel has a weight feature (W); and
an artificial intelligence (AI) module electrically connected to the CIM memory array and providing a first weight scaling coefficient (Sw) and a first partial sum scaling coefficient (Sp), wherein the AI module is configured to:
(A) perform a first scaling operation on the weight feature (W), the first weight scaling coefficient (Sw), and the first partial sum scaling coefficient (Sp) to obtain a first scaling weight (WS), wherein the first weight scaling coefficient (Sw) and the first partial sum scaling coefficient (Sp) are fused into a first fused scaling coefficient;
(B) quantize the first scaling weight (WS) to obtain a first quantized weight (Q(WS)), and perform a convolution summation operation on the first quantized weight (Q(WS)) and the input feature (F-in) to obtain a first convolution sum; and
(C) quantize the first convolution sum to obtain a first quantized convolution sum, and perform a first inverse scaling operation of the first scaling operation on the first quantized convolution sum to obtain a forward propagation result.

11. The CIM device as claimed in claim 10, wherein:
the initial weight scaling coefficient (Sw0) is between 0 and 1; and
the initial partial sum scaling factor (Sp0) is between Sw0 and 1.

12. The CIM device as claimed in claim 10, wherein:
the first scaling operation is an amplification operation, and the first scaling weight (WS) equals to W*(1/(Sw*Sp)).

13. The CIM device as claimed in claim 10, wherein:
the step of quantizing the first scaling weight (WS) defines a maximum value and a minimum value for the first scaling weight (WS) and then rounds the maximum value and the minimum value.

14. The CIM device as claimed in claim 10, wherein:
the step of quantizing the first convolution sum defines a maximum value and a minimum value for the first convolution sum and then rounds the maximum value and the minimum value.

15. The CIM device as claimed in claim 10, wherein the first inverse scaling operation includes bitwise shifting the first quantized convolution sum.

16. The CIM device as claimed in claim 10, wherein:
the weight feature (W) has a weight bit number;
the pre-training quantization model includes an analog-to-digital (ADC) unit, and the ADC unit has an ADC bit number, an ADC step size, an ADC resolution range and an ADC quantization accuracy;
the first weight scaling coefficient (Sw) is related to the weight bit number and a weight standard deviation;
the first partial sum scaling factor (Sp) is related to the ADC bit number, the ADC step size and a partial sum standard deviation;
under the condition that the ADC bit number is fixed, the ADC step size is related to the ADC resolution range and the ADC quantization accuracy; and
the ADC unit further has a reference voltage, and in steps (b)-(e), the first weight scaling coefficient (Sw) and the first partial sum scaling coefficient (Sp) are used to adjust the weight feature (W), so that the forward propagation result satisfies the reference voltage.

17. A training method that uses an AI module to train scaling coefficients, comprising the following steps:
(a) providing an input feature (F-in), plural convolution kernels, and a first fusion scaling coefficient, wherein each of the plural convolution kernels has a weight feature (W), and the first fusion scaling coefficient includes a first weight scaling factor (Sw) and a first partial sum scaling factor (Sp);
(b) performing a first scaling operation on the weight feature (W) and the first fusion scaling coefficient to obtain a first scaling weight (WS); and
(c) quantizing the first scaling weight (WS) to obtain a first quantized weight (Q(WS)), and performing a convolution sum operation on the first quantized weight (Q(WS)) and the input feature (F-in) to obtain a first convolution sum.

18. The training method as claimed in claim 17, wherein:
the initial weight scaling coefficient (Sw0) is between 0 and 1;
the initial partial sum scaling factor (Sp0) is between Sw0 and 1;
the first scaling operation is an amplification operation, and the first scaling weight (WS) equals to W*(1/(Sw*Sp));
the step of quantizing the first scaling weight (WS) defines a first maximum value and a first minimum value for the first scaling weight (WS) and then rounds the first maximum value and the first minimum value;
the step of quantizing the first convolution sum defines a second maximum value and a second minimum value of the first convolution sum and then rounds the second maximum value and the second minimum value;
the training method further comprises step (d) of quantizing the first convolution sum to obtain a first quantized convolution sum, and performing a first inverse scaling operation associated with the first scaling operation on the first quantized convolution sum to obtain a forward propagation result; and
the first inverse scaling operation includes bitwise shifting the first quantized convolution sum.

19. The training method as claimed in claim 17, wherein:
each of the plural convolution kernels corresponds to a CIM memory array;
the steps (a) to (c) are performed in sequence; and
the training method further comprises the following steps:
obtaining a weight gradient of the weight feature (W), a weight scaling gradient of the first weight scaling coefficient (Sw), and a partial sum scaling gradient of the first partial sum scaling coefficient (Sp) according to the forward propagation result;
respectively updating the weight feature (W), the first weight scaling coefficient (Sw) and the first partial sum scaling coefficient (Sp) to obtain a subsequent weight feature, a second weight scaling coefficient and a second partial sum scaling coefficient according to the weight gradient of the weight feature (W), the weight scaling gradient of the first weight scaling coefficient (Sw) and the partial sum scaling gradient of the first partial sum scaling coefficient (Sp), wherein:
the weight feature (W) has a weight bit number;
the AI model includes an analog-to-digital (ADC) unit, and the ADC unit has an ADC bit number, an ADC step size, an ADC resolution range and an ADC quantization accuracy;
the first weight scaling coefficient (Sw) is related to the weight bit number and a weight standard deviation;
the first partial sum scaling factor Sp is related to the ADC bit number, the ADC step size and a partial sum standard deviation;
under the condition that the ADC bit number is fixed, the ADC step size is related to the ADC resolution range and the ADC quantization accuracy; and
the training method is used to satisfy a specification requirement of the ADC unit.

20. The training method as claimed in claim 17, further comprising the following iterative steps:
an iterative step 1:
calculating an initial weight scaling coefficient (Sw0) to scale the weight feature (W) to obtain an initial first scaling weight (W0) equal to W*(1/Sw0);
quantizing the initial first scaling weight (W0) to be a quantized initial first scaling weight Q(W0);
convoluting the quantized initial first scaling weight Q(W0) with the input feature (F-in) to obtain first plural partial sums; and
calculating an initial partial sum scaling coefficient (Sp0), summing the first plural partial sums to obtain a first summation result, and multiplying the first summation result by the initial weight scaling coefficient (Sw0);
an iterative step 2:
scaling the initial weight feature (W) by the initial partial sum scaling coefficient (Sp0) to obtain an initial second scaling weight (W1) equal to W*(1/Sp0):
recalculating the initial weight scaling coefficient (Sw0) to obtain the first weight scaling coefficient (Sw1) to scale the initial second scaling weight (W1) to obtain an initial third scaling weight (W2) equal to W1*(1/Sw1);
quantizing the initial third scaling weight (W2) to obtain a quantized initial fourth scaling weight (W3);
convoluting the quantized initial fourth scaling weight (W3) with the input feature (F-in) to obtain second plural partial sums;
recalculating the initial partial sum scaling factor (Sp0) to obtain the first partial sum scaling factor (Sp1); and
summing the second plural partial sums to obtain a second summation result, and multiplying the second summation result by the first weight scaling coefficient (Sw1) and the initial partial sum scaling coefficient (Sp0); and
an iterative step 3:
scaling the quantized initial weight feature (W) by the first weight scaling coefficient (Sw1) and the first partial sum scaling coefficient (Sp1) to obtain an initial fifth scaling weight (W4) equaling to W*(1/(Sw1*Sp1)).
